(19) United States
(12) Patent Application Publication
(10) Pub. No.: US 2026/0018654 A1
(43) Pub. Date: Jan. 15, 2026

(54) RIBBON PRESSING DEVICE

(71) Applicant: Suzhou Maxwell Technologies Co., Ltd., Suzhou (CN)

(72) Inventors: Yi TAO, Suzhou (CN); Kaile FANG, Suzhou (CN); Chenxin SHENG, Suzhou (CN)

(21) Appl. No.: 19/005,014

(22) Filed: Dec. 30, 2024

(30) Foreign Application Priority Data
Jul. 9, 2024 (CN) 202421611319.3

(51) Int. Cl. H01M 10/04

(52) U.S. Cl. CPC H01M 10/0481; H01M 10/0404

(57) ABSTRACT

A ribbon pressing device includes a jig body, multiple first pressing pin groups, and multiple second pressing pin groups, where the multiple first pressing pin groups are arranged at intervals on the jig body along a first direction, each of the multiple first pressing pin groups includes multiple first pressing pin units arranged at intervals along a second direction, and each of the multiple first pressing pin units is movable relative to the jig body; and the multiple second pressing pin groups are arranged at intervals on the jig body along the first direction, each of the multiple second pressing pin groups includes multiple second pressing pin units arranged at intervals along the second direction, and each of the multiple second pressing pin units is movable relative to the jig body.

### CROSS-REFERENCE TO RELATED APPLICATION(S)

This application claims priority to Chinese Patent Application No. 202421611319.3 filed Jul. 9, 2024, the disclosure of which is incorporated herein by reference in its entirety.

### TECHNICAL FIELD

The present disclosure relates to the field of battery manufacturing technology and, in particular, to a ribbon pressing device.

### BACKGROUND

For solar cells without bus bars and pad points, fingers and ribbons form an alloy during welding. Due to a small area of contact between a finger and a ribbon, the alloy has a smaller bonding force than an alloy formed by the ribbons, the bus bars, and the pad points of the conventional cells. Moreover, in the welding process, the ribbon is required to contact each finger to complete the welding. However, a pressing jig for the conventional cells has relatively sparse pressing pins and cannot guarantee the pressing effect on the ribbon. Meanwhile, when an end of the ribbon is clamped with a clip and the ribbon is laid, the end of the ribbon is being clamped and lifted. At this time, if the ribbon is pressed by the pressing pins of the pressing jig, the ribbon is possible to deform, affecting the welding effect.

### SUMMARY

The present disclosure provides a ribbon pressing device. The ribbon pressing device can not only guarantee the pressing effect on a ribbon but also relatively well prevent the ribbon from being pressed into deformation in the laying process of the ribbon.

The present disclosure discloses a ribbon pressing device. The ribbon pressing device includes a jig body; multiple first pressing pin groups arranged at intervals on the jig body along a first direction, where each of the multiple first pressing pin groups includes multiple first pressing pin units arranged at intervals along a second direction, and each of the multiple first pressing pin units is movable relative to the jig body; and multiple second pressing pin groups arranged at intervals on the jig body along the first direction, where each of the multiple second pressing pin groups includes multiple second pressing pin units arranged at intervals along the second direction, and each of the multiple second pressing pin units is movable relative to the jig body. Multiple second pressing pin groups are arranged between two adjacent first pressing pin groups. Along a vertical direction, a bottom wall of each of the multiple first pressing pin units is lower than a bottom wall of each of the multiple second pressing pin units, so that when a ribbon is pressed, each of the multiple first pressing pin units contacts the ribbon earlier than each of the multiple second pressing pin units.

In some embodiments, the distance between the bottom wall of each of the multiple first pressing pin units and the bottom wall of each of the multiple second pressing pin units is 1 mm to 5 mm.

In some embodiments, the distance between the centers of two adjacent second pressing pin units is less than or equal to 7 mm, and the distance between the centers of a first pressing pin unit and a second pressing pin unit that are adjacent to each other is less than or equal to 7 mm.

In some embodiments, the multiple first pressing pin units and the multiple second pressing pin units each include a pressing pin body penetrating through the jig body, where an end of the pressing pin body has a pressing head for contacting the ribbon; a limiting member sleeved on the other end of the pressing pin body and abutting against the jig body; and an elastic member sleeved on the pressing pin body, where an end of the elastic member abuts against the pressing head, and the other end of the elastic member abuts against the jig body. The length of the pressing pin body of each of the multiple first pressing pin units is greater than the length of the pressing pin body of each of the multiple second pressing pin units.

In some specific embodiments, the pressing head has a recessed portion recessed toward the jig body and an abutting surface surrounding the recessed portion, where the abutting surface abuts against the ribbon.

In some embodiment, the jig body includes a beam assembly with a frame structure, where the multiple first pressing pin units and the multiple second pressing pin units are arranged on the beam assembly; and mounting seats disposed at two ends of the beam assembly along the second direction and configured to be mounted onto an external holder.

In some specific embodiments, the beam assembly includes two fixing beams mounted on the mounting seats; multiple main beams arranged at intervals along the first direction, where each of the multiple main beams extends along the second direction and has two ends respectively connected to the two fixing beams; multiple auxiliary beams arranged at intervals along the second direction, where each of the multiple auxiliary beams has two ends respectively connected to two main beams adjacent to a respective one of the multiple auxiliary beams; and multiple cantilever beams arranged at intervals along the second direction and divided into two groups, where the two groups of cantilever beams are respectively connected to sides of two outermost main beams facing away from the multiple auxiliary beams. Each of the multiple first pressing pin units is disposed on one of the multiple main beams, and each of the multiple second pressing pin units is disposed on one of the multiple auxiliary beams and the multiple cantilever beams.

In some embodiments, each of the mounting seats includes a bottom housing provided with a mounting groove for accommodating an end portion of a respective beam assembly; and a cover housing connected to the bottom housing and configured to close the mounting groove.

In some specific embodiments, the bottom housing and/or the cover housing is connected to the end portion of the beam assembly through a connector.

In some specific embodiments, a rubber pad is provided on a side of the bottom housing facing away from the cover housing.

The ribbon pressing device of the present disclosure has the following beneficial effects: the ribbon pressing device includes the multiple first pressing pin groups and the multiple second pressing pin groups so that multiple first pressing pin units and multiple second pressing pin units of the entire ribbon pressing device are arranged in multiple rows and multiple columns and have a relatively large density, thereby ensuring the pressing effect on the ribbon. Meanwhile, the bottom wall of the first pressing pin unit is lower than the bottom wall of the second pressing pin unit. When a clamped end of the ribbon is clamped with a wire clip and the ribbon is laid, the first pressing pin units firstly press the ribbon to position the ribbon in a depressing process of the ribbon pressing device. After the wire clip is opened, the ribbon pressing device continues to depress so that the second pressing pin units press the ribbon, and the first pressing pin units and the second pressing pin units press the ribbon synchronously. Compared with the technical solution where all pressing pins press the ribbon in the laying process of the ribbon in the related art, the ribbon pressing device of this embodiment presses the ribbon through the first pressing pin units in the laying process of the ribbon and can relatively well prevent the ribbon from being pressed into deformation in the laying process of the ribbon.

Additional aspects and advantages of the present disclosure are partially set forth in the following description and partially apparent from the following description or are learned through the practice of the present disclosure.

### BRIEF DESCRIPTION OF DRAWINGS

FIG. 1 is a schematic view of a ribbon pressing device pressing a ribbon that is being laid according to an embodiment of the present disclosure.

FIG. 2 is a structural view of a ribbon pressing device according to an embodiment of the present disclosure.

FIG. 3 is an exploded view of a ribbon pressing device according to an embodiment of the present disclosure.

FIG. 4 is a structural view of a beam assembly according to an embodiment of the present disclosure.

FIG. 5 is a structural view of a first pressing pin unit according to an embodiment of the present disclosure.

### REFERENCE LIST

100 jig body
110 beam assembly
111 fixing beam
112 main beam
113 auxiliary beam
114 cantilever beam
120 mounting seat
121 bottom housing
1211 mounting groove
122 cover housing
210 first pressing pin group
220 second pressing pin group
201 pressing pin body
202 pressing head
2021 recessed portion
2022 abutting surface
203 limiting member
204 elastic member
300 connector
400 rubber pad
10 ribbon
101 clamped end

### DETAILED DESCRIPTION

The present disclosure is further described below in detail in conjunction with drawings and embodiments. It is to be understood that the embodiments described herein are intended to illustrate and not to limit the present disclosure. Additionally, it is to be noted that for ease of description, only part, not all, of structures related to the present disclosure are illustrated in the drawings.

In the description of the present disclosure, terms “joined”, “connected”, and “fixed” are to be understood in a broad sense unless otherwise expressly specified and limited. For example, the term “connected” may refer to “fixedly connected”, “detachably connected”, or “integrated”, may refer to “mechanically connected” or “electrically connected”, or may refer to “connected directly”, “connected indirectly through an intermediary”, “connected inside two components”, or an interaction relation between two components. For those of ordinary skill in the art, specific meanings of the preceding terms in the present disclosure may be understood based on specific situations.

In the present disclosure, unless otherwise expressly specified and limited, when a first feature is described as “on” or “below” a second feature, the first feature may be in direct contact with the second feature, or the first feature may be in contact with the second feature via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as “upper”, “lower”, and “right” are based on the drawings. These orientations or position relations are intended only to facilitate description and simplify operations and not to indicate or imply that a device or element referred to must have such particular orientations or must be configured or operated in such particular orientations. Thus, these orientations or position relations are not to be construed as limiting the present disclosure. Moreover, terms “first” and “second” are used only for distinguishing description and have no special meanings.

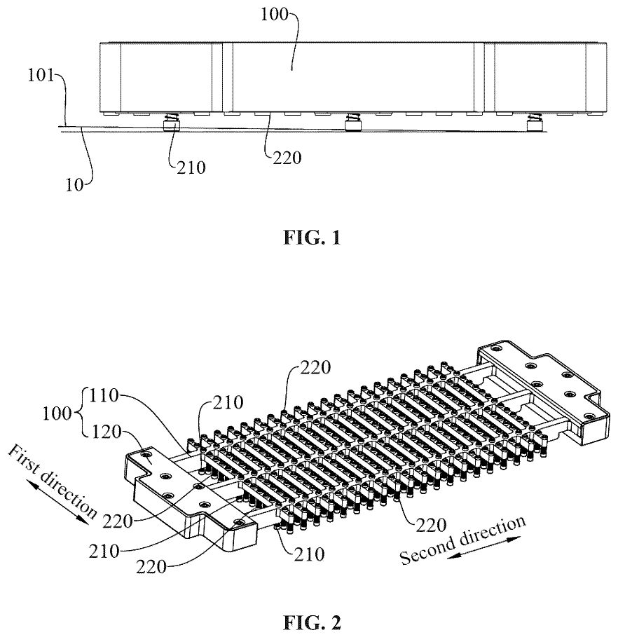

The present disclosure discloses a ribbon pressing device. As shown in FIGS. 1 and 2, the ribbon pressing device includes a jig body 100, multiple first pressing pin groups 210, and multiple second pressing pin groups 220, where the multiple first pressing pin groups 210 are arranged at intervals on the jig body 100 along a first direction, each first pressing pin group 210 includes multiple first pressing pin units arranged at intervals along a second direction, and each first pressing pin unit is movable relative to the jig body 100; and the multiple second pressing pin groups 220 are arranged at intervals on the jig body 100 along the first direction, each second pressing pin group 220 includes multiple second pressing pin units arranged at intervals along the second direction, and each second pressing pin unit is movable relative to the jig body 100. Multiple second pressing pin groups 220 are arranged between two adjacent first pressing pin groups 210. Along a vertical direction, a bottom wall of the first pressing pin unit is lower than a bottom wall of the second pressing pin unit, so that when a ribbon 10 is pressed, the first pressing pin unit contacts the ribbon 10 earlier than the second pressing pin unit.

It is to be understood that the ribbon pressing device includes the multiple first pressing pin groups 210 and the multiple second pressing pin groups 220 so that multiple first pressing pin units and multiple second pressing pin units of the entire ribbon pressing device are arranged in multiple rows and multiple columns and have a relatively large density, thereby ensuring the pressing effect on the ribbon 10. Meanwhile, the bottom wall of the first pressing pin unit is lower than the bottom wall of the second pressing pin unit. When a clamped end 101 of the ribbon 10 is clamped with a wire clip and the ribbon 10 is laid, the first pressing pin units firstly press the ribbon 10 to position the ribbon 10 in a depressing process of the ribbon pressing device. After the wire clip is opened, the ribbon pressing device continues to depress so that the second pressing pin units press the ribbon 10, and the first pressing pin units and the second pressing pin units press the ribbon 10 synchronously. Compared with the technical solution where all pressing pins press the ribbon in the laying process of the ribbon in the related art, the ribbon pressing device of this embodiment presses the ribbon 10 through the first pressing pin units in the laying process of the ribbon 10 and can relatively well prevent the ribbon 10 from being pressed into deformation in the laying process of the ribbon 10.

Optionally, the distance between the bottom wall of the first pressing pin unit and the bottom wall of the second pressing pin unit is 1 mm to 5 mm. It is to be understood that too large a distance between the bottom wall of the first pressing pin unit and the bottom wall of the second pressing pin unit increases the size of the ribbon pressing device and is not conducive to the lightweight design of the ribbon pressing device, and too small a distance between the bottom wall of the first pressing pin unit and the bottom wall of the second pressing pin unit increases a probability that the second pressing pin unit accidentally contacts the ribbon 10 in the laying process of the ribbon 10 and increases the probability of deformation of the ribbon 10. In this embodiment, the distance between the bottom wall of the first pressing pin unit and the bottom wall of the second pressing pin unit is controlled in a range of 1 mm to 5 mm, which can not only facilitate the lightweight design of the ribbon pressing device but also reduce the probability that the second pressing pin unit accidentally contacts the ribbon 10 in the laying process of the ribbon 10, thereby preventing the deformation of the ribbon 10. Of course, in other embodiments of the present disclosure, the distance between the bottom wall of the first pressing pin unit and the bottom wall of the second pressing pin unit may be selected according to actual needs and is not limited to the preceding limits.

Optionally, the distance between the centers of two adjacent second pressing pin units is less than or equal to 7 mm, and the distance between the centers of a first pressing pin unit and a second pressing pin unit that are adjacent to each other is less than or equal to 7 mm. Thus, the pressing effect on the ribbon 10 can be further guaranteed. Of course, in other embodiments of the present disclosure, the distance between the centers of two adjacent second pressing pin units and the distance between the centers of the first pressing pin unit and the second pressing pin unit that are adjacent to each other may be selected according to actual needs and are not limited to the preceding limits.

Optionally, the jig body 100 is made of a metal material and may be made of a highly transparent and temperature-resistant material such as an aluminum alloy.

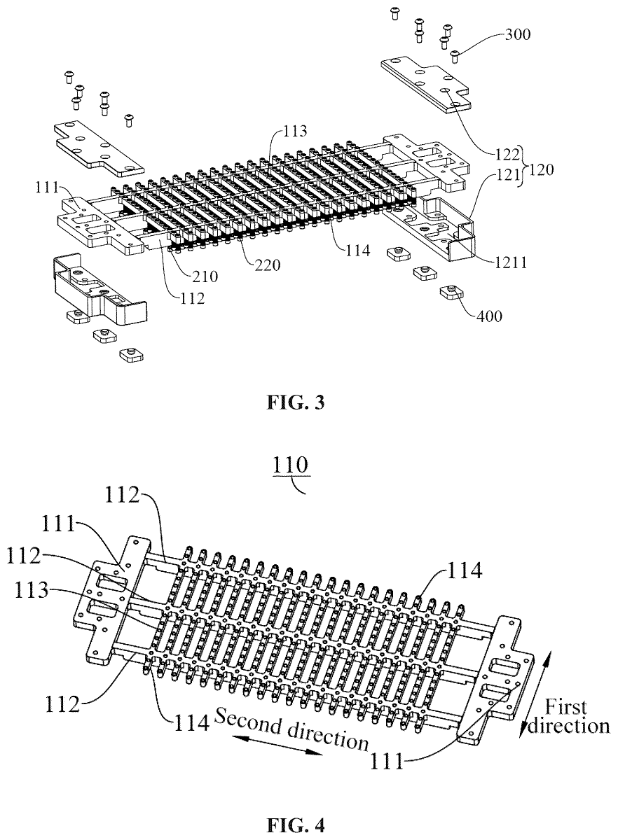

As shown in FIGS. 2 and 3, the jig body 100 includes a beam assembly 110 and mounting seats 120, where the beam assembly 110 has a frame structure, the first pressing pin units and the second pressing pin units are arranged on the beam assembly 110, and the mounting seats 120 are disposed at two ends of the beam assembly 110 along the second direction and configured to be mounted onto an external holder. It is to be understood that the beam assembly 110 has the frame structure so that the entire jig body 100 is formed as a hollow grid structure, thereby increasing the light transmission area of the ribbon pressing device and facilitating welding. The mounting seats 120 are configured to be mounted onto the external holder so that the entire ribbon pressing device can be conveniently mounted to the external holder.

It is to be additionally noted that the mounting seats 120 may be directly made of a magnetic material so that the mounting seats 120 can be directly attracted onto the external holder, or the mounting seats 120 may be made of a ferromagnetic material which is non-magnetic itself, and magnets are provided on the external holder.

Further, as shown in FIG. 4, the beam assembly 110 includes two fixing beams 111, three main beams 112, forty auxiliary beams 113, and forty cantilever beams 114, where the fixing beams 111 are mounted on the mounting seats 120; the three main beams 112 are arranged at intervals along the first direction, and each main beam 112 extends along the second direction and has two ends respectively connected to the two fixing beams 111; the forty auxiliary beams 113 are arranged at intervals along the second direction, and each auxiliary beam 113 has two ends respectively connected to two main beams 112 adjacent to a respective one auxiliary beam 113; and the forty cantilever beams 114 are arranged at intervals along the second direction and divided into two groups, and the two groups of cantilever beams 114 are respectively connected to sides of two outermost main beams 112 facing away from the auxiliary beams 113. The first pressing pin units are disposed on the main beams 112, and the second pressing pin units are disposed on the auxiliary beams 113 and the cantilever beams 114. It is to be understood that the beam assembly 110 includes the fixing beams 111, the main beams 112, the auxiliary beams 113, and the cantilever beams 114 so that in one aspect, the mounting of the first pressing pin units and the second pressing pin units can be facilitated, and in the other aspect, the entire beam assembly 110 can form a hollow structure, facilitating an increase in the light transmission area of the beam assembly 110 and facilitating the welding of the ribbon 10.

Optionally, one main beam 112 is connected to the middle of each fixing beam 111, and the other two main beams 112 are respectively located on two sides of the fixing beam 111. Thus, in the laying process of the ribbon 10, the ribbon 10 can be pressed by the first pressing pin units located in the middle, thereby ensuring the pressing effect on the ribbon 10.

Optionally, the fixing beams 111, the main beams 112, the auxiliary beams 113, and the cantilever beams 114 are integrally formed. Thus, the manufacturing of the beam assembly 110 is facilitated.

Of course, it is to be additionally noted that in other embodiments of the present disclosure, the number of main beams 112, the number of auxiliary beams 113, and the number of cantilever beams 114 may be selected according to actual needs.

As shown in FIG. 3, each mounting seat 120 includes a bottom housing 121 and a cover housing 122, where the bottom housing 121 is provided with a mounting groove 1211 for accommodating the fixing beam 111, and the cover housing 122 is connected to the bottom housing 121 and configured to close the mounting groove 1211. It is to be understood that the mounting seat 120 includes the bottom housing 121 and the cover housing 122. In the actual assembly process, the fixing beam 111 is inserted into the mounting groove 1211, and then the bottom housing 121 is fastened to the cover housing 122 so that the assembly is very convenient.

As shown in FIG. 3, the bottom housing 121 and the cover housing 122 are connected to the fixing beam 111 through connectors 300. It is to be understood that in the actual assembly process, the fixing beam 111 is inserted into the mounting groove 1211 and then fixed to the bottom housing 121 through the connectors 300, and the cover housing 122 is fastened to the bottom housing 121 and then fixed to the fixing beam 111 through the connectors 300. Thus, the bottom housing 121 and the cover housing 122 are both connected to the fixing beam 111 so that the strength of a connection between the mounting seat 120 and the beam assembly 110 can be improved.

Optionally, rubber pads 400 are provided on a side of the bottom housing 121 facing away from the cover housing 122. It is to be understood that the thickness of each rubber pad 400 may be adjusted according to actual needs to facilitate the adjustment of a mounting height of the ribbon pressing device on the external holder.

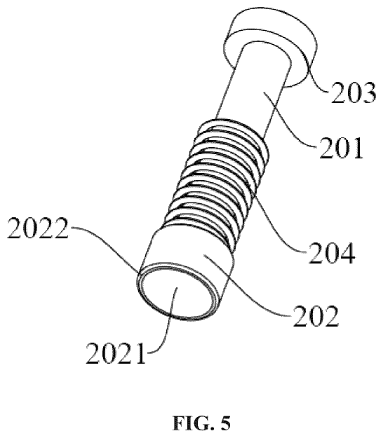

As shown in FIG. 5, the first pressing pin unit and the second pressing pin unit each include a pressing pin body 201, a limiting member 203, and an elastic member 204, where the pressing pin body 201 penetrates through the beam assembly 110, an end of the pressing pin body 201 has a pressing head 202 for contacting the ribbon 10; the limiting member 203 is sleeved on the other end of the pressing pin body 201 and abuts against the jig body 100; and the elastic member 204 is sleeved on the pressing pin body 201, an end of the elastic member 204 abuts against the pressing head 202, and the other end of the elastic member 204 abuts against the beam assembly 110. The length of the pressing pin body 201 of the first pressing pin unit is greater than the length of the pressing pin body 201 of the second pressing pin unit.

It is to be understood that in the actual mounting process, the elastic member 204 is sleeved on the pressing pin body 201, the pressing pin body 201 penetrates through the main beam 112, the auxiliary beam 113, or the cantilever beam 114 so that the elastic member 204 abuts against the beam assembly 110, and then the limiting member 203 is mounted onto the pressing pin body 201. Thus, the pressing pin body 201 can not only move up and down relative to the main beam 112, the auxiliary beam 113, or the cantilever beam 114 but also be prevented from falling off.

Optionally, the pressing head 202 has a recessed portion 2021 recessed toward the jig body 100 and an abutting surface 2022 surrounding the recessed portion 2021, where the abutting surface 2022 abuts against the ribbon 10. It is to be understood that the recessed portion 2021 can reduce a contact area between the pressing head 202 and the ribbon 10, and the abutting surface 2022 can guarantee the pressing of the ribbon 10. The recessed portion 2021 and the abutting surface 2022 are both disposed on the pressing head 202 so that the pressing effect on the ribbon 10 can be guaranteed, and a probability that the ribbon 10 is accidentally damaged can be reduced.

Optionally, an initial elastic force of the elastic member 204 in one or more groups of second pressing pin units on each side of the beam assembly 110 is greater than an initial elastic force of the elastic member 204 in the remaining pressing pin units. Thus, the pressing effect of the second pressing pin units on the edge can be enhanced to achieve better welding. Elastic members 204 of different specifications or initial pre-compression amounts of the elastic members 204 are changed so that the initial elastic forces can be achieved.

In the description of the specification, reference terms such as “some embodiments” and “other embodiments” are intended to mean that specific features, structures, materials, or characteristics described in conjunction with such embodiments or examples are included in at least one embodiment or example of the present disclosure. In the specification, the illustrative description of the preceding terms does not necessarily refer to the same embodiments or examples. Moreover, the described specific features, structures, materials, or characteristics may be combined appropriately in any one or more embodiments or examples.

What is claimed is:

1. A ribbon pressing device, comprising:
a jig body;
a plurality of first pressing pin groups arranged at intervals on the jig body along a first direction, wherein each of the plurality of first pressing pin groups comprises a plurality of first pressing pin units arranged at intervals along a second direction, and each of the plurality of first pressing pin units is movable relative to the jig body; and
a plurality of second pressing pin groups arranged at intervals on the jig body along the first direction, wherein each of the plurality of second pressing pin groups comprises a plurality of second pressing pin units arranged at intervals along the second direction, and each of the plurality of second pressing pin units is movable relative to the jig body;
wherein a plurality of second pressing pin groups are arranged between two adjacent first pressing pin groups; and along a vertical direction, a bottom wall of each of the plurality of first pressing pin units is lower than a bottom wall of each of the plurality of second pressing pin units, so that when a ribbon is pressed, each of the plurality of first pressing pin units contacts the ribbon earlier than each of the plurality of second pressing pin units.

2. The ribbon pressing device according to claim 1, wherein a distance between the bottom wall of each of the plurality of first pressing pin units and the bottom wall of each of the plurality of second pressing pin units is 1 mm to 5 mm.

3. The ribbon pressing device according to claim 1, wherein a distance between centers of two adjacent second pressing pin units is less than or equal to 7 mm, and a distance between centers of a first pressing pin unit and a second pressing pin unit that are adjacent to each other is less than or equal to 7 mm.

4. The ribbon pressing device according to claim 1, wherein the plurality of first pressing pin units and the plurality of second pressing pin units each comprise:
a pressing pin body penetrating through the jig body, wherein an end of the pressing pin body has a pressing head for contacting the ribbon;
a limiting member sleeved on another end of the pressing pin body and abutting against the jig body; and
an elastic member sleeved on the pressing pin body, wherein an end of the elastic member abuts against the pressing head, and another end of the elastic member abuts against the jig body;
wherein a length of a pressing pin body of each of the plurality of first pressing pin units is greater than a length of a pressing pin body of each of the plurality of second pressing pin units.

5. The ribbon pressing device according to claim 4, wherein the pressing head has a recessed portion recessed toward the jig body and an abutting surface surrounding the recessed portion, wherein the abutting surface abuts against the ribbon.

6. The ribbon pressing device according to claim 1, wherein the jig body comprises:
a beam assembly with a frame structure, wherein the plurality of first pressing pin units and the plurality of second pressing pin units are arranged on the beam assembly; and
mounting seats disposed at two ends of the beam assembly along the second direction and configured to be mounted onto an external holder.

7. The ribbon pressing device according to claim 6, wherein the beam assembly comprises:
two fixing beams mounted on the mounting seats;
a plurality of main beams arranged at intervals along the first direction, wherein each of the plurality of main beams extends along the second direction and has two ends respectively connected to the two fixing beams;
a plurality of auxiliary beams arranged at intervals along the second direction, wherein each of the plurality of auxiliary beams has two ends respectively connected to two main beams adjacent to a respective one of the plurality of auxiliary beams; and
a plurality of cantilever beams arranged at intervals along the second direction and divided into two groups, wherein the two groups of cantilever beams are respectively connected to sides of two outermost main beams facing away from the plurality of auxiliary beams;
wherein each of the plurality of first pressing pin units is disposed on one of the plurality of main beams, and each of the plurality of second pressing pin units is disposed on one of the plurality of auxiliary beams and the plurality of cantilever beams.

8. The ribbon pressing device according to claim 6, wherein each of the mounting seats comprises:
a bottom housing provided with a mounting groove for accommodating an end portion of a respective beam assembly; and
a cover housing connected to the bottom housing and configured to close the mounting groove.

9. The ribbon pressing device according to claim 8, wherein at least one of the bottom housing and the cover housing is connected to the end portion of the beam assembly through a connector.

10. The ribbon pressing device according to claim 8, wherein a rubber pad is provided on a side of the bottom housing facing away from the cover housing.

11. The ribbon pressing device according to claim 2, wherein the jig body comprises:
a beam assembly with a frame structure, wherein the plurality of first pressing pin units and the plurality of second pressing pin units are arranged on the beam assembly; and
mounting seats disposed at two ends of the beam assembly along the second direction and configured to be mounted onto an external holder.

12. The ribbon pressing device according to claim 3, wherein the jig body comprises:
a beam assembly with a frame structure, wherein the plurality of first pressing pin units and the plurality of second pressing pin units are arranged on the beam assembly; and
mounting seats disposed at two ends of the beam assembly along the second direction and configured to be mounted onto an external holder.

13. The ribbon pressing device according to claim 4, wherein the jig body comprises:
a beam assembly with a frame structure, wherein the plurality of first pressing pin units and the plurality of second pressing pin units are arranged on the beam assembly; and
mounting seats disposed at two ends of the beam assembly along the second direction and configured to be mounted onto an external holder.

14. The ribbon pressing device according to claim 5, wherein the jig body comprises:
a beam assembly with a frame structure, wherein the plurality of first pressing pin units and the plurality of second pressing pin units are arranged on the beam assembly; and
mounting seats disposed at two ends of the beam assembly along the second direction and configured to be mounted onto an external holder.
